(19) United States
(12) Patent Application Publication
(10) Pub. No.: US 2019/0223498 A1
(43) Pub. Date: Jul. 25, 2019

(54) CONDUCTIVE CONTACT STRUCTURE, BATTERY ASSEMBLY AND ELECTRONIC CIGARETTE HAVING SAME

(71) Applicant: SHENZHEN IVPS TECHNOLOGY CO., LTD., Shenzhen (CN)

(72) Inventor: Junwei OUYANG, Shenzhen (CN)

(73) Assignee: SHENZHEN IVPS TECHNOLOGY CO., LTD., Shenzhen (CN)

(21) Appl. No.: 16/145,145

(22) Filed: Sep. 27, 2018

(30) Foreign Application Priority Data
Jan. 19, 2018 (CN) 201820100564.6

(51) Int. Cl. A24F 47/00; H01M 2/34; H01M 2/10

(52) U.S. Cl. CPC A24F 47/008; H01M 2220/30; H01M 2/1055; H01M 2/34

(57) ABSTRACT

The present disclosure discloses a conductive contact structure, a battery assembly and an electronic cigarette having same. The battery assembly comprises a cover body and a main body in which a main control board is built, wherein installation space is formed between the cover body and the main body. The conductive contact structure comprises a negative electrode assembly, a sealing member, an insulating assembly and a positive electrode assembly, which are provided in the installation space sequentially. The negative electrode assembly passes through the cover body to abut against the sealing member, and is provided with a through-hole. One end of the insulating assembly covers the positive electrode assembly in the main body, and the other end abuts against the sealing member. The positive electrode assembly partially passes through the insulating assembly and the sealing member sequentially.

### TECHNICAL FIELD

The present disclosure relates to a conductive contact structure, a battery assembly using the conductive contact structure, and an electronic cigarette using the battery assembly.

### BACKGROUND

Electronic cigarettes, also known as electronic cigarettes, are mainly used to quit smoking and replace conventional cigarettes. It has an appearance and taste similar to conventional cigarettes, and even has more tastes than conventional cigarettes. It can generate smoke, a taste and a feel like conventional cigarettes. Without tar, suspension particles and other harmful components in conventional cigarettes, electronic cigarettes have gradually replaced conventional cigarettes in the market. The existing electronic cigarettes supply power to the heat generating unit in the atomizer through the battery assembly, so that the heat generating unit heats the tobacco liquid to generate smoke under the driving of the battery assembly, thereby enabling the user to obtain a smoking experience.

However, in the battery assembly of the conventional electronic cigarette, the conductive contact structure for connecting the atomizer and the battery assembly is complicated in structure and has many components. A gap is easily generated between the components. The user generally always installs the atomizer in the battery assembly in the process of using the electronic cigarette. If an oil leakage preventing structure is weak in the atomizer, the tobacco liquid easily penetrates into the battery assembly from the conductive contact structure, thereby resulting in the phenomenon that the internal electrical components of the battery assembly is damaged.

### SUMMARY

The main object of the present disclosure is to provide a conductive contact structure, which aims to improve the sealing performance of the conductive contact structure and prevent the phenomenon that tobacco liquid penetrates into the battery assembly from the conductive contact structure.

In order to achieve the above object, the present disclosure provides a conductive contact structure applied to a battery assembly, wherein the battery assembly comprises a cover body and a main body in which a main control board is built, wherein installation space is formed between the cover body and the main body, wherein the conductive contact structure comprises a negative electrode assembly, a sealing member, an insulating assembly and a positive electrode assembly, which are provided in the installation space sequentially, the negative electrode assembly passes through the cover body (50) to abut against the sealing member, and is provided with a through-hole in which an external load is installed, one end of the insulating assembly covers the positive electrode assembly in the main body, and the other end abuts against the sealing member, the positive electrode assembly partially passes through the insulating assembly and the sealing member sequentially, and is received in the through-hole, and the main control board is electrically connected to the positive electrode assembly and the negative electrode assembly.

Preferably, one of the insulating assembly and the sealing member is provided with at least one positioning block, while the other thereof is provided with a positioning groove, one of the positioning blocks is inserted into one of the positioning grooves, and the sealing member is fixed to the insulating assembly.

Preferably, the sealing member comprises a large-diameter section and at least one small-diameter section located at an outer periphery of the large-diameter section, the large-diameter section blocks the through-hole and is provided with a retaining hole through which the positive electrode assembly passes, and the small-diameter section is provided with a positioning groove/positioning block.

Preferably, the retaining hole is aligned with a central position of the through-hole, and the diameter of the retaining hole is smaller than that of the through-hole.

Preferably, the insulating assembly comprises a limiting plate and an insulating plate provided in cooperation with the side structure of the positive electrode assembly, the limiting plate is installed on the main body and forms a receiving groove, one end of the insulating plate covers the receiving groove and the other end is provided with at least one positioning block, one end of the positive electrode assembly is elastically installed on the receiving groove and abuts against the insulating plate, and the other end passes through the insulating plate and the retaining hole and is received in the through-hole.

Preferably, the insulating assembly further comprises an insulating ring, which is sleeved on the outer periphery of the positive electrode assembly in the through-hole and abuts against the inner wall of the through-hole.

Preferably, the negative electrode assembly comprises a connector and a conductive ring, one end of the connector is embedded in the cover body, the other end is received in the installation space, the through-hole is provided at the connector, the conductive ring is sleeved to the connector and abuts against the sealing member, the connector is limited to the installation space, and the conductive ring electrically conducts the connector and the main control board.

Preferably, the positive electrode assembly comprises a conductive column and a conductive elastic piece, one end of the conductive column passes through the insulating assembly and the sealing member and is received in the through-hole, and the other end is fixedly connected to the conductive elastic piece, and the conductive elastic piece is fixedly installed on the main control board and electrically conducts the conductive column and the conductive elastic piece.

The present disclosure further provides a battery assembly, which comprises a cover body, a main body in which a main control board is built, and a conductive contact structure, wherein installation space is formed between the cover body and the main body, the conductive contact structure comprises a negative electrode assembly, a sealing member, an insulating assembly and a positive electrode assembly, which are provided in the installation space sequentially, the negative electrode assembly passes through the cover body (50) to abut against the sealing member, and is provided with a through-hole in which an external load is installed, one end of the insulating assembly covers the positive electrode assembly in the main body, and the other end abuts against the sealing member, the positive electrode assembly partially passes through the insulating assembly and the sealing member sequentially, and is received in the through-hole, and the main control board is electrically connected to the positive electrode assembly and the negative electrode assembly.

The present disclosure further provides an electronic cigarette, wherein the electronic cigarette further comprises a battery assembly, which comprises a cover body, a main body in which a main control board is built, and a conductive contact structure, wherein installation space is formed between the cover body and the main body, the conductive contact structure comprises a negative electrode assembly, a sealing member, an insulating assembly and a positive electrode assembly, which are provided in the installation space sequentially, the negative electrode assembly passes through the cover body (50) to abut against the sealing member, and is provided with a through-hole in which an external load is installed, one end of the insulating assembly covers the positive electrode assembly in the main body, and the other end abuts against the sealing member, the positive electrode assembly partially passes through the insulating assembly and the sealing member sequentially, and is received in the through-hole, and the main control board is electrically connected to the positive electrode assembly and the negative electrode assembly.

The conductive contact structure of the technical solution of the present disclosure can effectively prevent the tobacco liquid from penetrating from the outer periphery of the negative electrode assembly and the gap between the through-hole and the insulating assembly by abutting the negative electrode assembly against the sealing member through the cover body. At the same time, the positive electrode assembly is received in the through-hole after partially passing through the insulating assembly and the sealing member sequentially, that is, the sealing member is sleeved on the positive electrode assembly to further prevent the phenomenon that tobacco liquid penetrates from the direct gap between the positive electrode assembly and the insulating assembly, effectively improve the sealing performance of the conductive contact structure and prevent the phenomenon that tobacco liquid penetrates into the battery assembly from the conductive contact structure.

### BRIEF DESCRIPTION OF THE DRAWINGS

For a better illustration of the embodiments of the present disclosure or the technical solution in the prior art, accompanying drawings needed in the description of the embodiments or the prior art are simply illustrated below. Obviously, the accompanying drawings described below are some embodiments of the present disclosure. For those skilled in the art, other accompanying drawings may be obtained according to the structure shown in these accompanying drawings without creative work.

FIG. 1 is a schematic exploded diagram illustrating a connecting structure of a conductive contact structure installed on a battery assembly according to the present disclosure;

FIG. 2 is a schematic cross-sectional diagram illustrating a connecting structure of a conductive contact structure installed on the battery assembly according to the present disclosure;

FIG. 3 is another schematic cross-sectional diagram illustrating a connecting structure of a conductive contact structure installed on the battery assembly according to the present disclosure;

FIG. 4 is a schematic perspective diagram illustrating a connecting structure of a positive electrode assembly installed on the main body according to the present disclosure;

FIG. 5 is a schematic perspective diagram illustrating a connecting structure of a sealing member according to the present disclosure;

FIG. 6 is a schematic perspective diagram illustrating a connecting structure of a positive electrode assembly according to the present disclosure;

FIG. 7 is a schematic perspective diagram illustrating a connecting structure of a negative electrode assembly installed on the cover body according to the present disclosure.

### DESCRIPTION OF THE REFERENCE NUMBERS

| Reference | | | |
|---|---|---|---|
| number | Name of part | Reference number | Name of part |
| 100 | battery assembly | 131 | insulating plate |
| 10 | conductive contact | 1311 | positioning block |
| | structure | | |
| 11 | negative electrode | 132 | insulating ring |
| | assembly | | |
| 111 | connector | 14 | sealing member |
| 1111 | through-hole | 141 | large-diameter |
| | | | section |
| 112 | conductive ring | 1411 | retaining hole |
| 1121 | wiring pin | 142 | small-diameter |
| | | | section |
| 12 | positive electrode | 1421 | positioning groove |
| | assembly | | |
| 121 | conductive column | 30 | main body |
| 1211 | receiving chamber | 31 | limiting plate |
| 122 | conductive elastic | 32 | receiving groove |
| | piece | | |
| 1221 | bending portion | 50 | cover body |
| 123 | elastic piece | 70 | installation space |
| 13 | insulating assembly | 90 | main control board |

The implementation of aims, the function features and the advantages of the present disclosure are described below in further detail in conjunction with embodiments with reference to the drawings.

### DETAILED DESCRIPTION

A clear and complete description as below is provided for the technical solution in the embodiments of the present disclosure in conjunction with the drawings in the embodiments of the present disclosure. Obviously, the embodiments described hereinafter are simply part embodiments of the present disclosure, rather than all the embodiments. All other embodiments obtained by those skilled in the art based on the embodiments in the present disclosure without creative work are intended to be comprised in the scope of protection of the present disclosure.

It should be noted that all directional indications (such as top, bottom, left, right, front, behind . . . ) in the embodiments of the present disclosure are merely to illustrate a relative position relation, a relative motion condition, etc. between each part in a certain state (for example, the state shown in the drawings). If the state changes, the directional indication changes accordingly.

In addition, if terms “first”, “second”, etc. appear in the present disclosure, they are merely for the purpose of description, but cannot be understood as the indication or implication of relative importance or as the implicit indication of the number of the designated technical features; therefore, features defined by “first” and “second” may specifically or implicitly comprise at least one such feature. In addition, technical solutions of each embodiment of the present disclosure may be combined mutually; however, this must be carried out on the basis that those skilled in the art can implement the combination. When the combination of technical solutions has a conflict or cannot be implemented, it should be considered that such combination of technical solutions does not exist and is not in the scope of protection claimed by the present disclosure.

In the present disclosure, unless otherwise specifically stated and defined, terms “connected”, “fixed”, etc. should be interpreted expansively. For example, “fixed” may be fixed connection, detachable connection, or integration; may be mechanical connection or electrical connection; direct connection, indirect connection through an intermediate, or internal communication between two elements or interaction of two elements, unless otherwise specifically defined. Those skilled in the art can understand the specific implication of the above terms in the present disclosure according to specific conditions.

The present disclosure provides a conductive contact structure 10 applied to a battery assembly 100. The battery assembly 100 comprises a cover body 50 and a main body 30 in which a main control board 90 is built. The installation space 70 is formed between the cover body 50 and the main body 30. The battery assembly 100 is used to supply power to an external load. In the embodiment of the present disclosure, for example, the external load is an atomizer. The battery assembly 100 and the atomizer form an electronic cigarette.

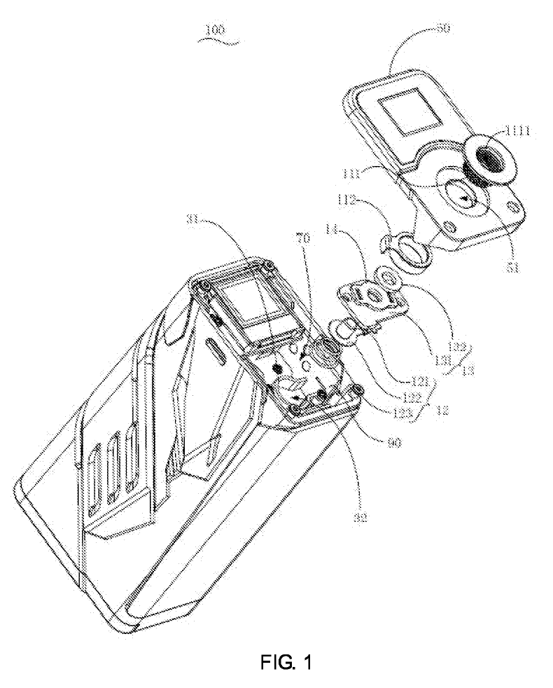

Referring to FIG. 1 to FIG. 7, in the embodiment of the present disclosure, the conductive contact structure 10 comprises a negative electrode assembly 11, a sealing member 14, an insulating assembly 13 and a positive electrode assembly 12, which are provided in the installation space 70 sequentially. The negative electrode assembly 11 passes through the cover body (50) to abut against the sealing member 14, and is provided with a through-hole 1111 in which an external load is installed. One end of the insulating assembly 13 covers the positive electrode assembly 12 in the main body 30, and the other end abuts against the sealing member 14. The positive electrode assembly 12 partially passes through the insulating assembly 13 and the sealing member 14 sequentially, and is received in the through-hole 1111. The main control board 90 is electrically connected to the positive electrode assembly 12 and the negative electrode assembly 11.

The conductive contact structure 10 of the technical solution of the present disclosure can effectively prevent the tobacco liquid from penetrating from the outer periphery of the negative electrode assembly 11 and the gap between the through-hole 1111 and the insulating assembly 13 by abutting the negative electrode assembly 11 against the sealing member 14 through the cover body 50. At the same time, the positive electrode assembly 12 is received in the through-hole 1111 after partially passing through the insulating assembly 13 and the sealing member 14 sequentially, that is, the sealing member 14 is sleeved on the positive electrode assembly 12 to further prevent the phenomenon that tobacco liquid penetrates from the direct gap between the positive electrode assembly 12 and the insulating assembly 13, effectively improve the sealing performance of the conductive contact structure 10 and prevent the phenomenon that tobacco liquid penetrates into the battery assembly 100 from the conductive contact structure 10.

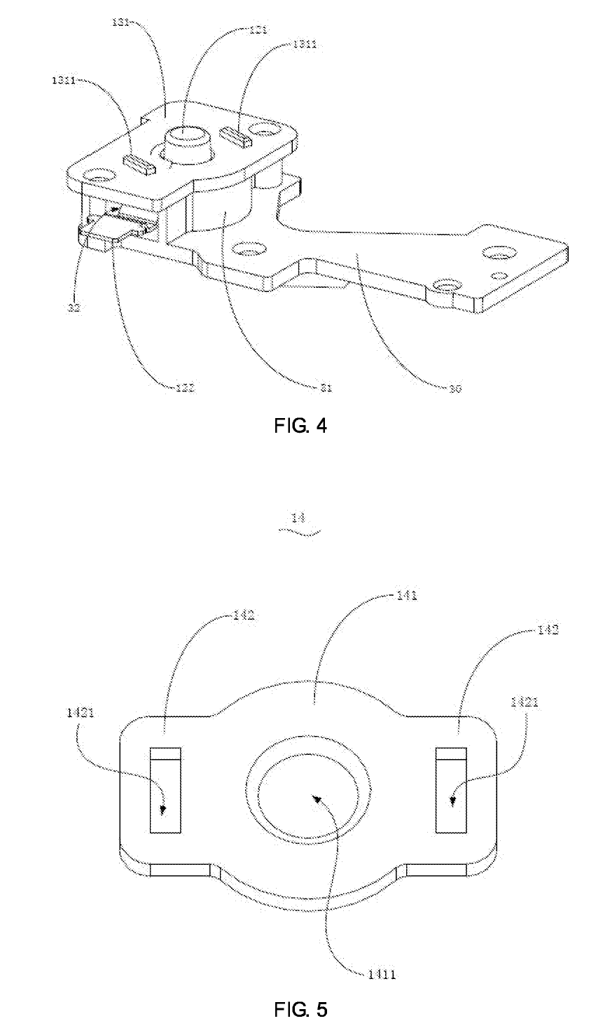

Specifically, as shown in FIG. 1, FIG. 4 and FIG. 5, in the embodiment of the present disclosure, one of the insulating assembly 13 and the sealing member 14 is provided with at least one positioning block 1311, while the other thereof is provided with a positioning groove 1421, one of the positioning blocks 1311 is inserted into one of the positioning grooves 1421, and the sealing member 14 is fixed to the insulating assembly 13. Here, in the embodiment, the sealing member 14 is made of an elastic silicone material. One end of the insulating assembly 13 toward the cover body 50 is provided with two positioning blocks 1311 at intervals. The two positioning blocks 1311 are provided at opposite sides of the positive electrode assembly 12 at intervals. The sealing member 14 is correspondingly provided with two positioning grooves 1421. The sealing member 14 is fixed to the insulating assembly 13 by buckling the two positioning blocks to the two positioning grooves 1421. The connection is stable, facilitating the installation of the sealing member 14, and at the same time, effectively preventing the phenomenon that the sealing member 14 moves during use so as to generate a gap. Moreover, the elastic silicone material has a certain elastic force, and can be closely fit with the insulating assembly 13 and the negative electrode assembly 11 to further avoid a gap.

It is to be understood that, in the actual application process, the number and the installing position of the positioning blocks 1311 and the positioning grooves 1421 are not limited to the manner in which the positioning blocks 1311 and the positioning grooves 1421 are provided at opposite sides of the positive electrode assembly 12 at intervals in the above embodiment. The manner in which the user may select other numbers and installing positions according to the specific size or shape also falls within the scope of protection of the present disclosure.

Specifically, as shown in FIG. 5, in the embodiment of the present disclosure, the sealing member 14 comprises a large-diameter section 141 and at least one small-diameter section 142 located at an outer periphery of the large-diameter section 141. The large-diameter section 141 blocks the through-hole 1111 and is provided with a retaining hole 1411 through which the positive electrode assembly 12 passes, and the small-diameter section 142 is provided with a positioning groove 1421/positioning block 1311. Here, in the embodiment, two small-diameter sections 142 are provided at both sides of the large-diameter section 141. The large-diameter section 141 blocks the through-hole 1111, thereby effectively preventing oil from penetrating from the through-hole 1111. The two small-diameter sections 142 are integrally formed with the large diameter section 141, and two positioning grooves 1421 are sleeved on the two positioning blocks 1311 provided by the insulating assembly 13, preventing the one-piece sealing member 14 with a large diameter from sealing, effectively saving the material cost, and reducing the installation space 70 at the same time.

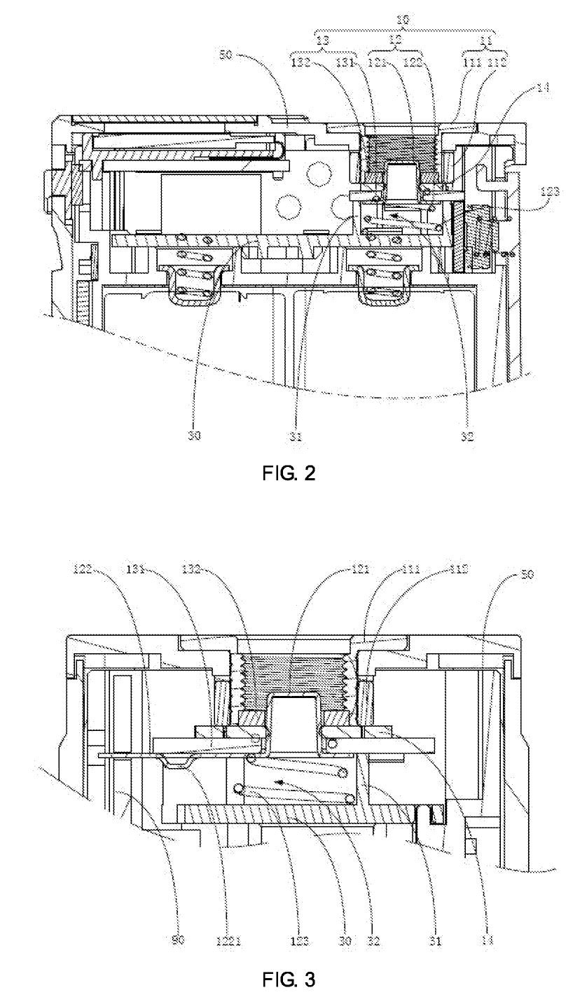

Specifically, as shown in FIG. 2 or FIG. 3, the retaining hole 1411 is aligned with a central position of the through-hole 1111, and the diameter of the retaining hole 1411 is smaller than that of the through-hole 1111. Here, in the embodiment, the retaining hole 1411 is aligned with a central position of the through-hole 1111, and the diameter of the retaining hole 1411 is smaller than that of the through-hole 1111 so as to effectively ensure that the positive electrode assembly 12 is received in the center of the through-hole 1111 and always maintains a certain distance from the negative electrode assembly 11 to prevent the safety hazard that the positive electrode assembly 12 and the negative electrode assembly 11 are in direct contact to cause a short circuit.

Specifically, as shown in FIG. 1 to FIG. 4, in the embodiment of the present disclosure, the insulating assembly 13 comprises a limiting plate 31 and an insulating plate 131 provided in cooperation with the side structure of the positive electrode assembly 12. The limiting plate 31 is installed on the main body 30 and forms a receiving groove 32. One end of the insulating plate 131 covers the receiving groove 32 and the other end is provided with at least one positioning block 1311. One end of the positive electrode assembly 12 is elastically installed on the receiving groove 32 and abuts against the insulating plate 131, and the other end passes through the insulating plate 131 and the retaining hole 1411 and is received in the through-hole 1111. Here, in the embodiment, the limiting plate 31 forms a receiving groove 32, one end of the positive electrode assembly 12 is elastically installed on the receiving groove 32, the insulating plate 131 covers the receiving groove 32, and the positive electrode assembly 12 is covered on the main body 30, so that the outer periphery of the positive electrode assembly 12 is wrapped, which can effectively prevent the phenomenon that the external conductive element (not shown) accidentally touches the positive electrode assembly 12 to cause a short circuit, prevent the phenomenon that the positive electrode assembly 12 shakes during use so as to be in contact with the negative electrode assembly 11 to cause a short circuit, and effectively improve the yield and safety of the battery assembly 100.

Specifically, as shown in FIG. 1 to FIG. 3 or FIG. 7, in the embodiment of the present disclosure, the insulating assembly 13 further comprises an insulating ring 132, which is sleeved on the outer periphery of the positive electrode assembly 12 in the through-hole 1111 and abuts against the inner wall of the through-hole 1111. Here, in the embodiment, since the sealing member 14 is made of an elastic silicone material and has a soft texture, in order to prevent the phenomenon that the positive electrode assembly 12 is in direct contact with the negative electrode assembly 11 to cause a short circuit in a long-term use, an insulating ring 132 is sleeved on the outer periphery of the positive electrode assembly 12 in the through-hole 1111, and the end of the negative electrode assembly 11 near the positive electrode assembly 12 gradually increases or is provided with a limiting step so as to adapt to and abut against the insulating ring 132 so that the positive electrode assembly 12 and the negative electrode assembly 11 are not in direct contact with each other to cause a short circuit.

Specifically, as shown in FIG. 1 to FIG. 3 or FIG. 7, in the embodiment of the present disclosure, the negative electrode assembly 11 comprises a connector 111 and a conductive ring 112. One end of the connector 111 is embedded in the cover body 50, and the other end is received in the installation space 70. The through-hole 1111 is provided at the connector 111. The conductive ring 112 is sleeved to the connector 111 and abuts against the sealing member 14. The connector 111 is limited to the installation space 70, and the conductive ring 112 electrically conducts the connector 111 and the main control board 90. Here, in the embodiment, one end of the connector 111 is embedded in the cover body 50, the other end is received in the installation space 70, and the conductive ring 112 is sleeved to the connector 111 using an interference fit and abuts against the sealing member 14 so as to effectively prevent the tobacco liquid from penetrating from the gap between the conductive ring 112 and the insulating assembly 13, and fix the connector 111 to the cover body 50 simultaneously. The connection is stable without using screws. The contact electrode of the external load is fixedly electrically connected to the connector 111 through the through-hole 1111 at the same time, and the conductive contact area is large, thereby effectively ensuring the stability of electrical conduction and avoiding the burning sensation when a large current passes.

Specifically, as shown in FIG. 7, in the embodiment of the present disclosure, the outer periphery of the conductive ring 112 extends with a wiring pin 1121 which is provided with a wire hole. A wire is soldered to the wiring pin 1121 through the wire hole to realize electrical conduction and effectively facilitate wiring welding in a small space.

Specifically, as shown in FIG. 1 to FIG. 3, in the embodiment of the present disclosure, the inner wall of the through-hole 1111 is provided with a connecting thread (not shown) to be connected with the contact electrode of the load. Here, in the embodiment, the connecting thread is connected to the contact electrode of the load, which facilitates the installation and disassembly. At the same time, the connection is more stable and less likely to cause a shake.

Specifically, as shown in FIG. 3 or FIG. 4, in the embodiment of the present disclosure, the positive electrode assembly 12 comprises a conductive column 121 and a conductive elastic piece 122. One end of the conductive column 121 passes through the insulating assembly 13 and the sealing member 14 and is received in the through-hole 1111, and the other end is fixedly connected to the conductive elastic piece 122. The conductive elastic piece 122 is fixedly installed on the main control board 90 and electrically conducts the conductive column 121 and the conductive elastic piece 122. Here, in the embodiment, the conductive column 121 passes through the insulating plate 131 of the insulating assembly 13 and the sealing member 14 sequentially and is received in the connecting hole, so that the conductive column 121 always maintains a certain distance from the negative electrode assembly 11. When the load is installed on the conductive assembly, the negative contact electrode at the outer periphery of the load is electrically connected to the connector 111 of the negative electrode assembly 11, and the positive contact electrode of the load abuts against the conductive column 121 to form an electrical circuit; at the same time, the positive electrode assembly 12 is provided with a conductive elastic piece 122 so that the positive electrode assembly 12 can be welded to the main control board 90 through the conductive elastic piece 122 to be electrically connected, thereby avoiding the connection using a wire, further improving the product quality and reducing the safety hazard such as the wire cold solder joint detachment. At the same time, wires are directly distributed on the main control board 90 to be electrically connected to the wiring pin 1121, the contact area is much larger than that when a wire is used for connection, and a load with a large current may be withstood. Moreover, the conductive elastic piece 122 has a certain elastic force. When the load is installed, the conductive column 121 is squeezed, and the conductive elastic piece 122 applies a certain elastic force to the conductive column 121, so that the conductive column 121 abuts against the positive contact electrode of the load, effectively improving the stability of the current conduction.

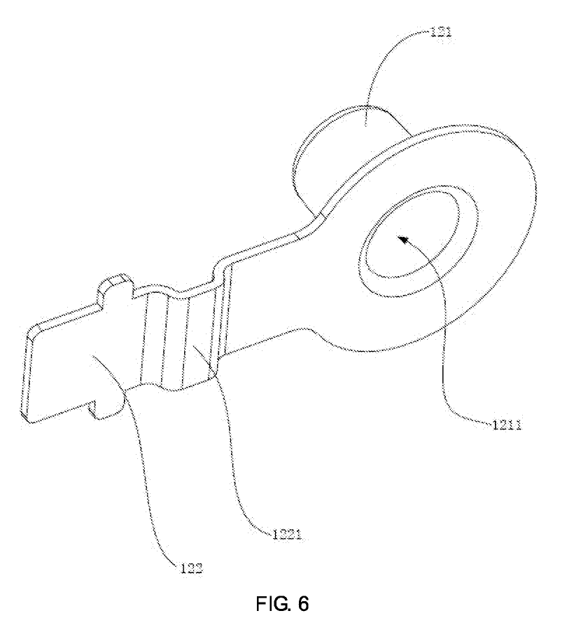

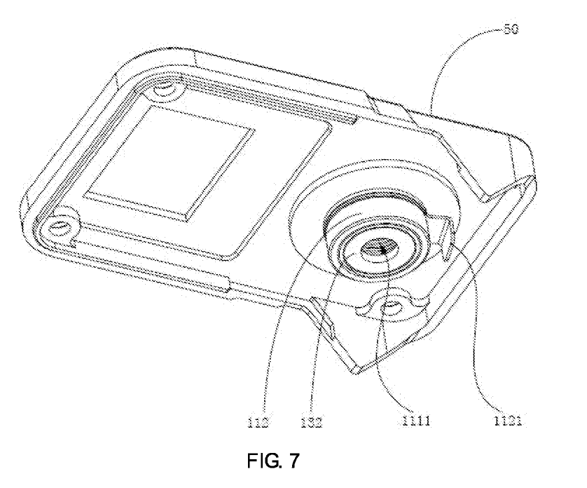

Specifically, as shown in FIG. 3 or FIG. 6, in the actual application process, in the technical application of the embodiment, a bending portion 1221 is provided on the conductive elastic piece 122 to further improve the elastic force of the conductive elastic piece 122.

Specifically, as shown in FIG. 1 to FIG. 3, in the embodiment of the present disclosure, the positive electrode assembly 12 further comprises an elastic member 123. The two ends of the elastic member 123 abut against the main body 30 and the conductive column 121, respectively. Here, in the embodiment, the elastic member 123 is provided in the receiving groove 32 to further improve the elastic force of the conductive column 121, so that the conductive column 121 can be closely fit with the positive contact electrode of the load, and at the same time, the activity of the conductive column 121 can be improved, to facilitate interfacing with various types of loads.

Specifically, as shown in FIG. 2, FIG. 3 or FIG. 6, in the embodiment of the present disclosure, the inner groove wall of the receiving groove 32 is further provided with an elastic member fixing column (not shown) toward the positive electrode assembly 12; or/and the conductive column 121 is provided with a receiving chamber 1211 for receiving the elastic member 123. Here, in the embodiment, an elastic member fixing column is provided, and then the elastic member 123 is sleeved to the elastic member fixing column, so that the phenomenon that the elastic member 123 shakes and displaces during use can be effectively prevented. Similarly, the receiving chamber 1211 for receiving the elastic member 123 is provided in the conductive column 121, so that the phenomenon that the elastic member 123 shakes and displaces during use can be effectively prevented, and at the same time, the structure is more compact and the installation space 70 is reduced.

It is to be understood that, in the actual application process, the elastic member 123 may use a compression spring or an elastic plastic, and is not limited to the above manner in which an elastic member fixing column or a receiving chamber 1211 is provided. For example, a conical spring may also be used. The manner in which the large-diameter end of the conical spring abuts against the limiting plate 31 so as to be fixed also falls within the scope of protection of the present disclosure.

Referring to FIG. 1, the present disclosure further provides a battery assembly 100 applied to the electronic cigarette, wherein the battery assembly 100 comprises a cover body 50, a main body 30 in which a main control board 90 is built, and a conductive contact structure 10. Refer to the above embodiment for the specific structure of the conductive contact structure 10. Due to the use of all the technical solutions of all the above embodiments, the battery assembly 100 has at least all the beneficial effects brought by the technical solutions of the above embodiments, which will not be described in detail herein.

The present disclosure further provides an electronic cigarette which comprises an atomizer and a battery assembly 100. Refer to the above embodiment for the specific structure of the battery assembly 100. Due to the use of all the technical solutions of all the above embodiments, the electronic cigarette has at least all the beneficial effects brought by the technical solutions of the above embodiments, which will not be described in detail herein.

The above are preferred embodiments of the present disclosure merely and are not intended to limit the patent scope of the present disclosure. Any equivalent structures made according to the description and the accompanying drawings of the present disclosure without departing from the idea of the present disclosure, or any equivalent structures applied in other relevant technical fields directly or indirectly are intended to be comprised in the patent protection scope of the present disclosure.

What is claimed is:

1. A conductive contact structure applied to a battery assembly, wherein the battery assembly comprises a cover body and a main body in which a main control board is built, wherein an installation space is formed between the cover body and the main body, characterized in that: the conductive contact structure comprises a negative electrode assembly, a sealing member, an insulating assembly and a positive electrode assembly, which are provided in the installation space sequentially, the negative electrode assembly passes through the cover body to abut against the sealing member, the negative electrode assembly is provided with a through-hole in which an external load is installed, one end of the insulating assembly covers the positive electrode assembly in the main body, and the other end abuts against the sealing member, the positive electrode assembly partially passes through the insulating assembly and the sealing member sequentially, the positive electrode assembly is received in the through-hole, and the main control board is electrically connected to the positive electrode assembly and the negative electrode assembly.

2. The conductive contact structure according to claim 1, wherein one of the insulating assembly and the sealing member is provided with at least one positioning block, while the other thereof is provided with a positioning groove, one of the positioning blocks is inserted into one of the positioning grooves, and the sealing member is fixed to the insulating assembly.

3. The conductive contact structure according to claim 2, wherein the sealing member comprises a large-diameter section and at least one small-diameter section located at an outer periphery of the large-diameter section, the large-diameter section blocks the through-hole and is provided with a retaining hole through which the positive electrode assembly passes, and the small-diameter section is provided with a positioning groove/a positioning block.

4. The conductive contact structure according to claim 3, wherein the retaining hole is aligned with a central position of the through-hole, and the diameter of the retaining hole is smaller than that of the through hole.

5. The conductive contact structure according to claim 3, wherein the insulating assembly comprises a limiting plate and an insulating plate provided in cooperation with the side structure of the positive electrode assembly, the limiting plate is installed on the main body and forms a receiving groove, one end of the insulating plate covers the receiving groove and the other end is provided with at least one positioning block, one end of the positive electrode assembly is elastically installed in the receiving groove and abuts against the insulating plate, and the other end passes through the insulating plate and the retaining hole, and is received in the through-hole.

6. The conductive contact structure according to claim 5, wherein the insulating assembly further comprises an insulating ring, which is sleeved on the outer periphery of the positive electrode assembly in the through-hole and abuts against the inner wall of the through-hole.

7. The conductive contact structure according to claim 1, wherein the negative electrode assembly comprises a connector and a conductive ring, one end of the connector is embedded in the insulating plate, the other end is received in the installation space, the through-hole is defined in the connector, the conductive ring sleeves the connector and abuts against the sealing member, the connector is limited to the installation space, and the conductive ring electrically conducts the connector and the main control board.

8. The conductive contact structure according to claim 1, wherein the positive electrode assembly comprises a conductive column and a conductive elastic piece, one end of the conductive column passes through the insulating assembly and the sealing member and is received in the through-hole, and the other end is fixedly connected to the conductive elastic piece, and the conductive elastic piece is fixedly installed on the main control board and electrically conducts the conductive column and the conductive elastic piece.

9. A battery assembly, wherein the battery assembly comprises the conductive contact structure according to claim 1.

10. An electronic cigarette comprising an atomizer, wherein the electronic cigarette further comprises the battery assembly according to claim 9.
